(19) United States
(12) Patent Application Publication
(10) Pub. No.: US 2018/0229252 A1
(43) Pub. Date: Aug. 16, 2018

(54) DEVICE FOR MIXING AND DISPENSING A CHEMICAL SUBSTANCE FORMED FROM REACTANT LIQUID COMPONENTS

(71) Applicant: Emecole Metro, LLC, Romeoville, IL (US)

(72) Inventor: John R. Kochan, JR., Naperville, IL (US)

(21) Appl. No.: 15/433,496

(22) Filed: Feb. 15, 2017

(51) Int. Cl. B05B 7/24; B65D 81/32; E01C 23/10; E02D 35/00; E04G 23/02; B01F 3/08; B01F 7/08; B01F 15/00

(52) U.S. Cl. CPC B05B 7/2472; B65D 81/325; E01C 23/10; E02D 35/005; B01F 2215/0047; B01F 3/0853; B01F 7/086; B01F 15/00857; E04G 23/0288

(57) ABSTRACT

A dispensing device is provided that has a nozzle that can mix together liquid reactants to dispense an expandable foam substance through concrete structures. The device features a liquid storage portion, a mixing portion and a dispensing portion. The storage portion includes liquid storage chambers in communication with a liquid passageway. The mixing portion has a mixing tube and a static mixer. The mixing tube has an elongated body with an interior passageway between opposing first and second ends. The static mixer is housed within the interior passageway of the mixing tube and features a plurality of curved baffles. The dispensing portion has a reservoir and a nozzle tip. The reservoir features a first end secured to the mixing tube and a second end communicating with a nozzle tip. The nozzle tip features a plurality of tine segments with each segment having a distal tip with an external gripping flange.

### FIELD

Embodiments presented herein relate generally to a device for mixing and dispensing a composite substance formed by a mixture of reactant liquids, and more specifically to a dispensing device having nozzle that can mix and supply an expandable foam substance into concrete structures to repair concrete settlement.

### BACKGROUND

It is generally known that concrete structures such as slabs, foundations or sidewalks can be susceptible to settlement over time. The most common causes of concrete slab settlement are drying and shrinking soils beneath a slab, poorly compacted fill soils, or a washout of soil. All of which can create a void below the slab. If the concrete is not strong enough to span the void, the slab can eventually crack, break and settle. This type of damage can cause serious destruction to a home or building.

Slabjacking (also referred to as “mudjacking” or “pressure grouting”) is a process that attempts to repair settled concrete by lifting a sunken concrete slab by pumping a grout-type substance (usually a composition of a cement mixture, dirt and water) through the concrete, effectively pushing it up from below. Foam leveling or foam jacking is a similar type of process, which uses a polyurethane foam instead of grout. Generally, the process involves mixing together two polyurethane liquid components and injecting the mixture under pressure through holes drilled into the concrete slab or structure being repaired. The two liquids components react with each other relatively quickly and expand into weaker soils and recesses below the slab. The expansion of the air bubbles in the injected mixture below the slab surface can produce a lifting action as the liquid resin reacts and becomes a structural foam, with the concrete being raised with the expansion of the foam mixture. The foam can then harden or solidify to seal/support the slab.

Although foam jacking or foam leveling is highly effective and has many advantages over slabjacking or mudjacking, the process still has certain drawbacks. In particular, current foam jacking services and operations require a large box truck or trailer to transport large volumes of the polyurethane liquid components. Such vehicles typically require large drums or storage containers (on the order of 55 gallon capacity) with heat control hoses several hundred feet long. Typically, the cost of such vehicles and equipment can exceed one hundred thousand dollars. In addition to the substantial cost of the equipment itself, traditional foam lifting services typically require considerable labor time and expense to load the service trucks and transport and assemble the hoses and dispensing equipment at the work site—with such processes generally requiring teams of multiple service technicians to complete the job in a timely manner. Further, when injecting the foam mixture through concrete, nozzles of known dispensing devices can get pushed out by pressure that is created from the expansion of the foam. In view of such limitations, there is a need for a more cost effective and portable dispensing device for performing foam jacking repair work and for a device having a nozzle which can stay engaged within an access hole when pressure builds from expansion of the foam.

### BRIEF DESCRIPTION OF THE DRAWINGS

FIG. 1A is a cross-section view taken along line C-C in FIG. 1B of an exemplary dispensing device according to embodiments described herein;

FIG. 1B is an end view of the device illustrated in FIG. 1A.

FIG. 1C is a detail view of the dispensing tip portion of the device illustrated in FIG. 1A.

FIG. 2A is a second cross-section view taken along line A-A in FIG. 2B of the device showing the dispensing tip portion in a flared position.

FIG. 2B is an end view of the device illustrated in FIG. 1A.

FIG. 2C is a detail view of the dispensing tip portion illustrated in FIG. 2A.

FIG. 3A is a cross-section view of the dispensing device of FIG. 1A inserted into an access hole of a concrete structure.

FIG. 3B is a detail view of the dispensing tip portion illustrated in FIG. 3A.

FIG. 4A is a cross-section view taken along line A-A of FIG. 4B of a second exemplary injection device according to embodiments described herein.

FIG. 4B is an end view of the device illustrated in FIG. 4A.

FIG. 4C is a detail view of the dispensing tip portion of the device illustrated in FIG. 4A.

FIG. 5A is a cross-section view of the dispensing device of FIG. 4A inserted into an access hole of a concrete structure.

FIG. 5B is a detail view of the dispensing tip portion illustrated in FIG. 5A.

### DETAILED DESCRIPTION

While the subject invention is susceptible of embodiment in many different forms, there are shown in the drawings, and will be described herein in specific detail, embodiments thereof with the understanding that the present disclosure is to be considered as an exemplification of the principles of the invention and is not intended to limit the invention to the specific embodiments illustrated.

Embodiments presented herein relate generally to a dispensing device for preparing a composite substance formed by a mixture of reactant liquids and for dispensing or injecting the composite substance through and/or under a slab or other concrete structure. Although such embodiments will herein be described in connection with preparing and dispensing polyurethane structural foam used in connection with the process of structural foam leveling, it will be recognized and understood that such embodiments can have broader applications and uses beyond such foam leveling services and can be suitable for carrying out any type of process which requires the mixing and dispensing a substance formed from different components.

As disclosed and illustrated schematically in the accompanying figures, exemplary embodiments generally feature a dispensing device having a multi-compartment liquid storage unit capable of storing two or more liquid reactants or chemicals and a nozzle featuring a dispensing tip in combination with a static mixer. As disclosed herein, such embodiments constitute a novel advancement over existing dispensing devices and offer numerous benefits/advantages in the field of structural foam leveling. In particular, embodiments disclosed herein provide a more cost-effective and portable dispensing device for performing foam jacking repair work. In particular, such devices can be readily transported, carried and operated by a single service technician at far less expense than onerous and bulky foam leveling equipment know in the art. Embodiments can further provide for an improved dispensing nozzle which can stay engaged within an access hole when pressure builds from expansion of the foam in a pocket under the concrete structure. In addition to the foregoing, numerous other benefits over prior art devices may be recognized and understood from the subject disclosure.

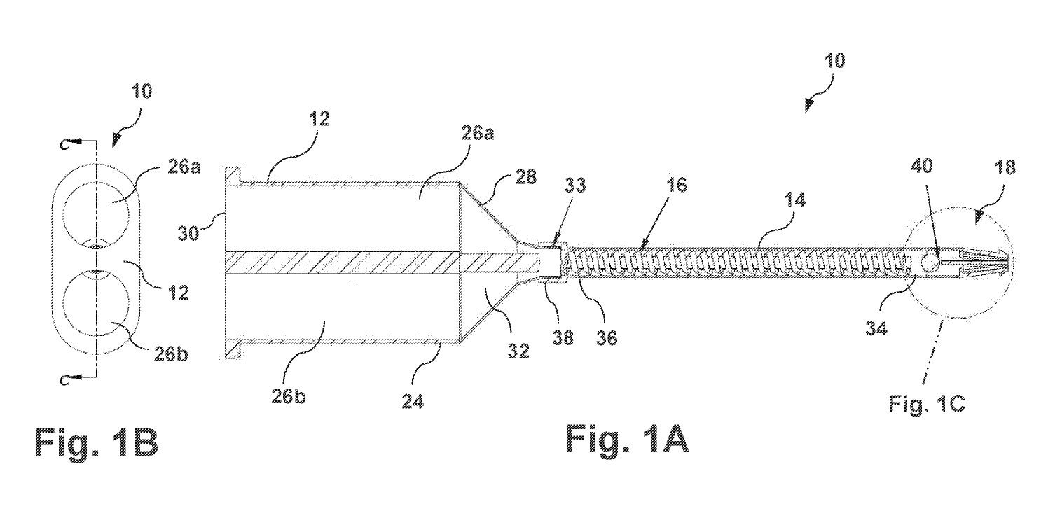

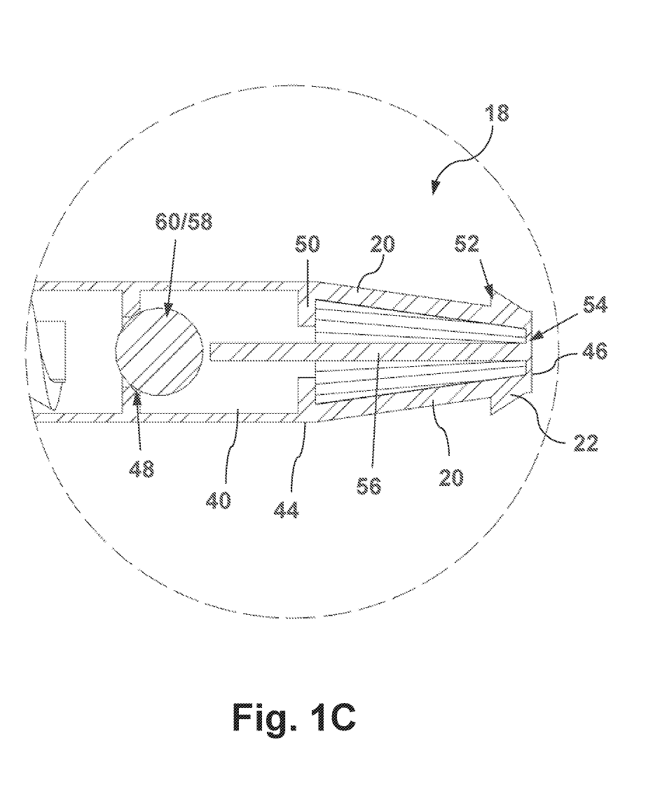

With reference now to the figures, FIGS. 1-5 illustrate an exemplary dispensing device 10 according to embodiments disclosed herein. As shown schematically in FIGS. 1A, 2A and 4A, device 10 can generally feature a storage portion comprising a multi-compartment liquid storage unit, frame or holder 12, a mixing portion comprising a mixing tube 14 and static mixer 16 and a dispensing portion comprising a nozzle 18 having a plurality of tine segments 20 featuring an engagement flange 22. As explained in greater detail below, the storage portion, mixing portion and dispensing portion of device 10 can be in liquid communication with one another to enable the liquids held in the storage unit 12 to travel from the storage portion, be blended together into a polyurethane foam substance and dispensed from device by nozzle 18.

As shown schematically in FIGS. 1A-B, 2A-B and 4A-B, liquid storage unit 12 can feature an exterior housing or frame 24 that can define or hold multiple separate liquid storage chambers 26a, 26b. As shown in the embodiments illustrated in FIGS. 1A, 2A and 4A, storage chambers 26a, 26b can be positioned side-by-side and have an elongated shape extending along housing 24 between opposing first and second ends 28, 30. Storage chambers 26a, 26b can each be configured to separately hold/store a volume of liquid therein and can be incorporated into housing 24, or can be separate components that can be removably secured to housing 24.

As shown schematically in FIGS. 1A-B, 2A-B and 4A-B, storage chambers 26a, 26b can be arranged in a symmetrical fashion around a longitudinal axis of housing 12, and can have a partition 13 separating the chambers 26a, 26b. Further, it will be recognized and understood that although the figures show device 10 having two storage chambers 26a, 26b for accommodating two separate liquids, a person of ordinary skill in the art will appreciate that embodiments of the invention can have a single storage chamber or multiple additional storage chambers as required. For example, a device having three or four storage chambers can be provided where accommodation of additional liquids is needed and to further keep such liquids separate from one another until the time that they are ready to be dispensed from device 10. Alternatively, one or more storage chambers can be provided with the liquid reactants already combined.

As shown schematically in FIGS. 1A, 2A and 4A, the first ends 28 of storage chambers 26a, 26b according to exemplary embodiments can have a tapered or funnel-like configuration 32 such that the interior volume of the chamber 26a, 26b decreases as the chambers 26a, 26b and/or housing 12 extend toward mixing tube 14. Prior to reaching mixing tube 14, the first ends 28 of storage chamber 26a, 26b can feature a permeable membrane, sheath, wall or barrier having one or more openings or passageways from which liquid can be expelled to exit chambers 26a, 26b and flow into a mixing chamber 33. Mixing chamber 33 can be a single compartment or conduit and/or multiple separate units. Once in mixing chamber 33, the liquids can begin to become mixed together and can be propelled or drawn into mixing tube 14 under pressure generated by a plunger and/or pressure loss generated by static mixer 16. It will be recognized that the tapered configuration of the first ends 28 of chambers 26a, 26b can facilitate smooth and even flow rates of the liquid ingredients as they enter mixing chamber 33. The tapered design can additionally generate additional pressure to advance the liquids through mixing chamber 33 and into mixing tube 14. Alternatively, chambers 26a, 26b can have a substantially uniform circumference along their length.

The second ends 30 of storage chambers 26a, 26b can be open to receive a plunger or piston (not shown) having a head portion with a size and shape closely corresponding to that of the interior of storage chambers 26a, 26b so that the head portion can closely fit within, and slide along, the inside of storage chambers 26a, 26b. Thus, when liquid is stored within storage chambers 26a, 26b, movement of the plunger towards the first end 28 of chambers 26a, 26b can create pressure within the chambers 26a, 26b which can push or expel the liquid out though the first end 28 and into mixing chamber 33 and mixing tube 14.

The plunger or piston can be configured for manual, mechanical, electrical or pneumatic operation, or by any additional pumping means for generating pressure. In addition, pressure can be generated by pressurized air held in storage chambers 26a, 26b, such as for example where pre-charged storage are used. Actuation of the plunger/piston can additionally be controlled by a processor, electronic controller and/or circuitry for automated operation. It will be understood that the plunger can be a single integral unit operating in multiple chambers 26a, 26b, or multiple plungers can be utilized separately for individual storage chambers 26a, 26b. It will further be recognized that where multiple separate plungers are provided, operation or movement of the plungers within storage chambers 26a, 26b can be coordinated or independent of one another.

FIGS. 1A, 2A and 4A illustrate the mixing tube 14 and static mixer 16 according to exemplary embodiments. As shown schematically, mixing tube 14 can have an elongated shape with opposing first and second ends 34, 36 and an interior passageway 28 therebetween for housing static mixer 16. The first end 34 of mixing tube 14 can comprise (or be removably secured to) dispensing nozzle 18 and the second end 36 can be removably secured to the first end 28 of housing 24 and/or storage chambers 26a, 26b. It will be recognized that mixing tube 14 can be comprised of a transparent or semi-transparent material in order to observe rotation of static mixer 16 and the fluid mixture being drawn through the interior passageway and blended by static mixer 16. Mixing tube 14 can also have a flat topped design and/or have a uniform cross-section along their length or a tapered design. It will be further recognized that mixing tube 14 can be provided in different lengths to accomplish thorough mixing of liquid components having different properties, chemicals or volumes or to accommodate other variables that can affect mixing efficiency such as, for example, different temperatures, pressures. For example, the length of the missing tube 14 can change based upon the use of different chemicals and the amount of contact time that is necessary before they can be thoroughly mixed and dispensed. Mixing tubes of different lengths can further be provided for purposes of accommodating concrete structures having different thicknesses so that, mixing tube 14 is of sufficient length to extend through the depth of the concrete.

Connector 38 can secure the second end 36 of mixing tube 14 to the first end 28 of housing 24 and/or mixing chamber 33. Connector 38 can be any type of fastening device, including, for example, an NPT connector having reciprocal male and female threaded adaptors which can screw together to create a seal to hold mixer 14 and housing 12 together. It will be understood that housing 12 and the mixing tube 14 can be removed from one another to facilitate cleaning, repair and/or maintenance of device 10.

Static mixer 16 can facilitate the continuous mixing and blending of liquids components within the interior passageway of mixing tube 14 between housing 12 and nozzle 18 before the liquid mixture is ultimately dispensed from device 10 at nozzle 18. Static mixer 16 can have an elongated shape having a helical design along its length which can rotate around a central longitudinal axis extending parallel to mixing tube 14. Mixer 16 can feature a sequence of baffles or panels which can rotate about the longitudinal axis and work to propel the liquid mixture towards nozzle 18. Mixer 16 can be comprised of metal, aluminum and/or a variety of plastics. Rotational movement of static mixer 16 can be driven by a loss of pressure as the liquid mixture flows through the mixer 16 and interior passageway of mixing tube 14 and can be further facilitated by the forward pressure created by the plunger which drives the liquids into mixing tube 14.

FIGS. 1C, 2C and 4C illustrate exemplary nozzles 18 according to embodiments disclosed herein. As shown schematically in FIGS. 1C, 2C and 4C, nozzle 18 can include a reservoir 40 and nozzle tip 42 comprised of a plurality of tine segments 20 that that can radially expand, flare or unfold to dispense the foam mixture and to further engage the bottom of a concrete structure. It will be understood that nozzle 18 and mixing tube 14 can be an integral single piece as shown in the figures, or that nozzle 18 and mixing tube 14 can be separate pieces that are removably secured together.

As shown schematically in FIGS. 1C, 2C and 4C, reservoir 40 can be in fluid communication with the first end 34 of mixing tube 14 via a reservoir intake hole 48 and can additionally feature a reservoir discharge hole 50 opposite the intake hole 48 and adjacent nozzle tip 42. The plurality of tine segments 20 of the nozzle tip 42 can have an elongated length between opposing proximal and distal ends 44, 46 with the proximal ends 44 of tine segments 20 being adjacent reservoir 40 and tine segments 20 extending longitudinally therefrom to the distal ends 46. The distal ends 46 of tine segments 20 can include an outwardly extending projection or engagement flange 22 along their outer surface, with the flange having a substantially flat edge 52 extending generally perpendicular to the central longitudinal axis around which static mixer 16 rotates. It will be recognized from the subject disclosure that the edge 52 of engagement flanges 22 can be configured to engage a bottom surface of a concrete structure to provide stability to nozzle 18 so that pressure generated by the expanding foam under the concrete structure does not disengage or push the nozzle 18 out of the access hole. According to exemplary embodiments, tine segments 20 can be spring-loaded to facilitate the radial expansion or flaring of segments 20.

The distal ends 46 of tine segments 20 can further comprise a breakaway member 54 that can engage or encircle the engagement flanges 22 to restrain or hold tine segments 20 in a closed position. Such breakaway member 54 can comprise a frangible connector such as, for example, a seal, membrane, bands or ring made of rubber or plastic, or other removable restraining means as known in the art that can be readily broken, cut or separated, or otherwise readily detached from engagement flanges 22.

FIGS. 1C, 2C and 4C additionally illustrate that reservoir 40 of nozzle 18 can optionally include a check valve 58 to ensure one-way flow of the foam mixture from mixing tube 14 into nozzle 18. FIGS. 1C, 2C and 4C illustrate exemplary embodiments showing check valve 58 as a ball check valve having a movable closing member 60 shown as a spherical ball or pellet which can move within reservoir 40. It will be recognized and understood, however, that check valve 58 (and reservoir 40) is/are entirely optional features and that embodiments presented herein can alternately feature a design where nozzle tip 42 is directly adjacent to the first end 28 of mixing tube 14. In addition, although FIGS. 1C, 2C and 4C illustrate check valve 58 as being a ball-type check valve, embodiments presented herein can alternately feature different types of check valves without limitation, including for example diaphragm check valves, swing check valves, tilting disc check valves and clapper valves.

Where check valve 58 of the type illustrated in FIGS. 1C, 2C and 4C is provided, closing member 60 can move between a closed position in reservoir 40 where it is seated against the intake hole 48 and an open position where it is displaced from intake hole 48. According to such embodiments, closing member 60 can have a diameter that is larger than intake hole 48 and thus when member 60 is seated against intake hole 48 it can seal intake hole 48 from within reservoir 40. It will be recognized that reverse flow of liquids or the foam mixture in reservoir 40 will cause closing member 60 to move to the closed position to seal the mixing tube from receiving back flow from reservoir 40. It will further be recognized that flow of liquids or the foam mixture from mixing tube 14 into reservoir 40 will cause closing member to move away from intake hole 48, thus permitting flow in the forward direction from mixing tube 14 to reservoir 40.

As shown schematically in FIGS. 1C, nozzle tip 42 can additionally comprise an internal plunger 56. Plunger 56 can be located in the inside of tip 42 between tine segments 20 and extend inward from the breakaway member 54 through discharge opening 50 into reservoir 40. According to such embodiments, fluid flow in the forward direction and movement of closing member 60 away from intake hole 48 can thrust plunger 50 forward and cause breakaway member 54 to break or tear, thus resulting in the expansion or flaring of nozzle tip 42 and widening of the dispensing path.

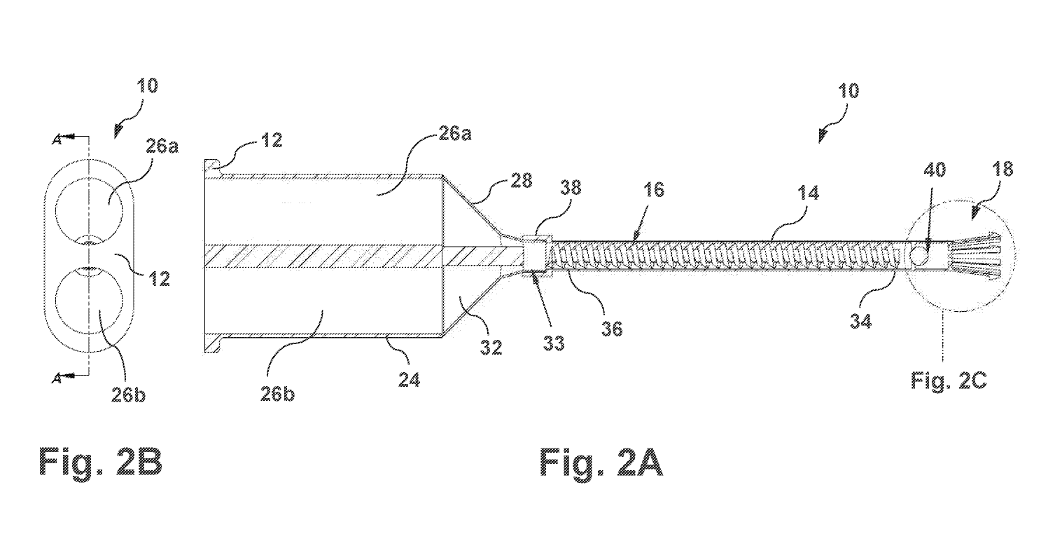

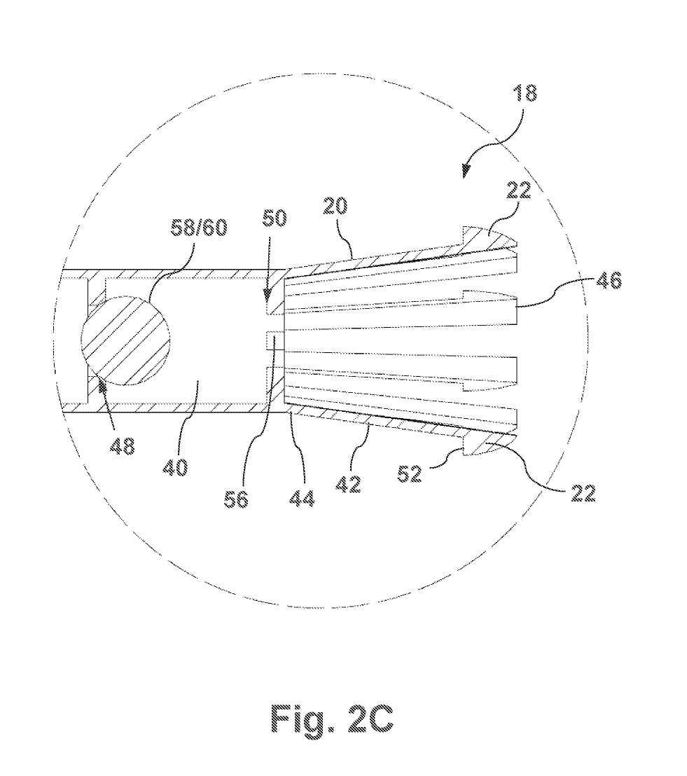

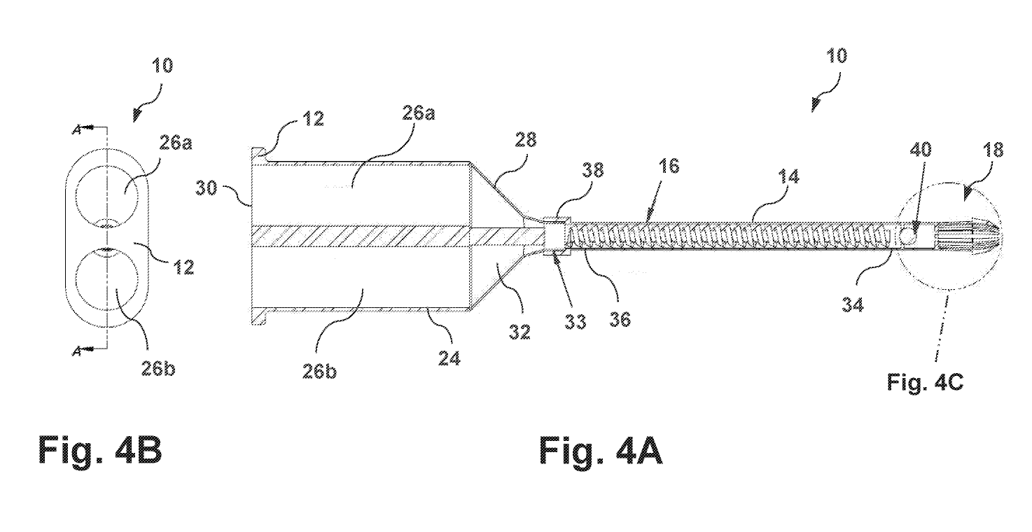

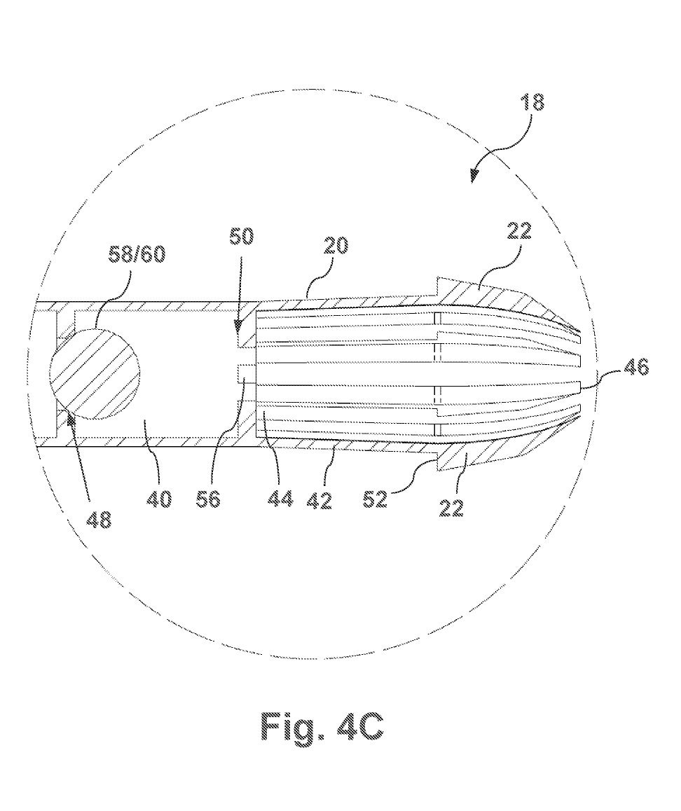

FIGS. 1A, 1C, 4A and 4C illustrate exemplary embodiments where nozzle tip 42 is in a closed position with tine segments 20 folded together sealing tip 42 from dispensing liquids from device 10. In this position, it can be seen that the distal ends 46 of tine segments 20 are merge together to form a seal closing nozzle tip 42. FIGS. 2A and 2C, by contrast, illustrate an exemplary embodiment where nozzle tip 42 is in an expanded or flared position, such as where liquid is being pushed through device 10 under pressure. As can be seen in FIGS. 2A and 2C, when flared, tine segments 20 flare or rotate radially outward from the end of reservoir 40 having discharge hole 50 such that the distal ends 46 of segments 20 separate and extend away from one another. When this occurs, the foam mixture is free to exit or be discharged from device 10 through discharge hole 50 and nozzle tip 42.

FIGS. 1A-C, 2A-C and 3A-B illustrate a nozzle tip 42 according to a first exemplary embodiment, with FIGS. 4A-C and 5A-B illustrating a nozzle tip 42 according to a second exemplary embodiment. As show schematically in FIGS. 1A-C, 2A-C and 3A-B, the nozzle tip 42 according to the first exemplary embodiment generally has a substantially straight tine segments 20 that converge or taper as they extend toward their distal ends 46 with the engagement flange. According to the second exemplary embodiment illustrated in FIGS. 4A-C and 5A-B, the proximal ends 44 of tine segments 20 can extend substantially parallel to one another until they reach extension flange 22. According to this embodiment, edge 52 of extension flange can extend outward with the body of the extension flange curving inward as it approaches the distal end of segments 20, thus forming a nozzle tip having a more bulbous distal end 46 as compared to the embodiment illustrated in FIGS. 1A-C, 2A-C and 3A-B.

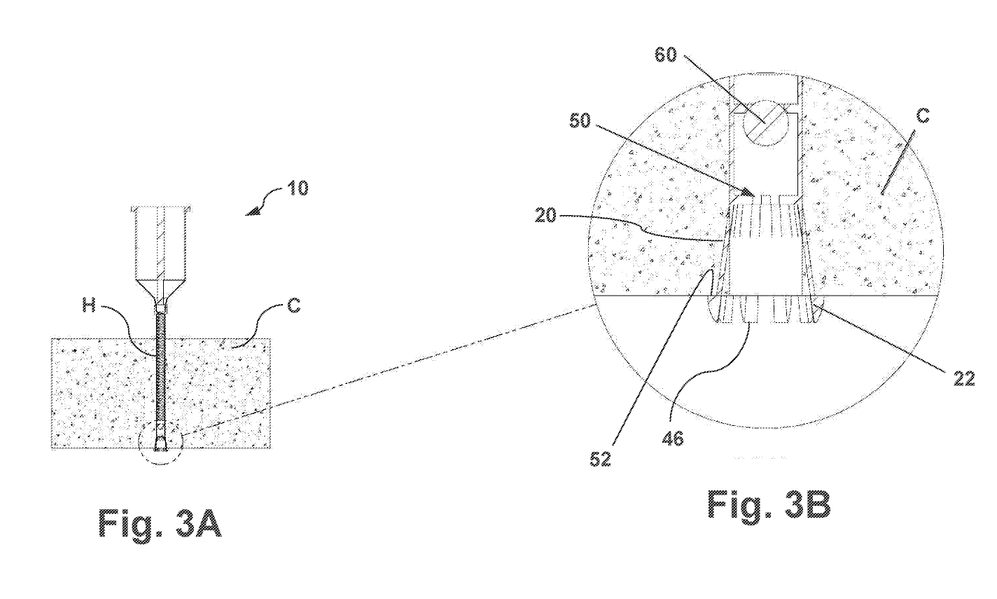

FIGS. 3A-B and 5A-B illustrate device 10 in a dispensing position according to exemplary embodiments and engaged to a concrete structure C. As shown schematically in FIGS. 3A-B and 5A-B, in a dispensing position, mixing tube 14 can extend through an access hole H extending through the depth or width of the structure C such that the distal end 46 of nozzle tip 42 is behind or below structure C (on the opposite side of the structure C from the side facing the liquid storage unit 12). In this position, upon the dispensing of the foam mixture from nozzle 18, the tine segments 20 can flare or open such that the edges 52 of engagement flanges 22 can catch or engage the bottom surface of the concrete structure to prevent the nozzle from being pushed back through or ejected from the access hole.

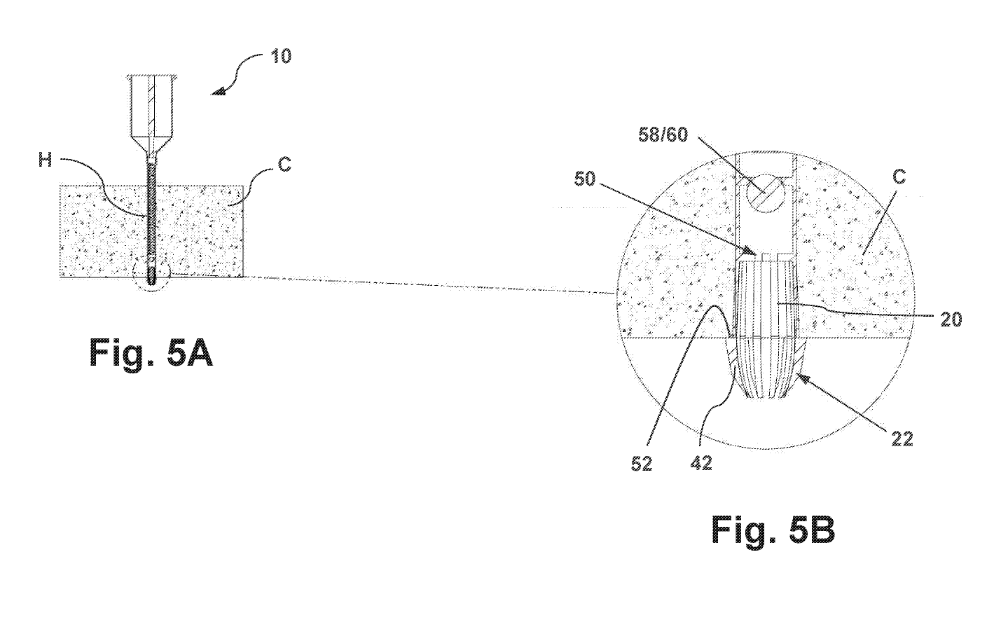

Thus, in operating device 10, reactant liquids can be poured, pumped or otherwise transferred into their respective storage chambers 26a, 26b where they are isolated from one another and device can be positioned as shown in FIGS. 3A and 5A such that nozzle 18 and mixing tube 14 are introduced into an access hole H in a concrete structure C. When it is time to begin injecting the polyurethane foam mixture, plunger or piston can be actuated to slide or move within storage chambers 26a, 26b towards the first end 28 of storage unit 12. As disclosed above, movement of the plunger can generate pressure within the storage chambers 26a, 26b so that the liquids are pushed or propelled out of their separate storage chambers 26a, 26b and into mixing chamber 33 at the first end 28 of storage unit 12. Once in the mixing chamber 33, the reactant liquids can start to mix together and can be drawn into mixing tube 14 where the mixture is further blended by rotational movement of static mixer 16 as the mixture travels along the interior passageway of mixing tube towards nozzle 18.

Upon reaching nozzle 18, the liquid/foam mixture can enter reservoir 40 and push closing member 60 forward to actuate plunger 56. In turn Plunger 56 can break the breakaway member 54 causing the tine segments 20 of nozzle tip 42 to separate and flare radially outward opening nozzle 18. With nozzle 18 open, the liquid/foam mixture can be dispensed from the nozzle 18 into the pocket or void below the concrete C. Outward movement of the tine segments 20 can additionally cause the edge 52 of engagement member to engage the bottom of the concrete structure C as disclosed above.

When a desired amount of the foam mixture has been dispensed below the concrete structure C, pressure can be withdrawn (or negative pressure introduced) to stop the flow of the liquid/foam mixture from device 10. When this occurs, the closing member 60 can move back to the seated position in reservoir 40 thus allowing plunger 56 to move upward. Such action can cause the tine segments 20 of nozzle tip 42 to retract back to the closed position, thus enabling the edge 52 or engagement member 22 to become disengaged from the bottom surface of the concrete structure C. The return of nozzle tip 42 to a closed (or nearly closed) position can enable the nozzle 18 to be extracted or pulled upward and out of the access hole.

From the foregoing, it will be observed that numerous variations and modifications can be effected without departing from the spirit and scope hereof. It is to be understood that no limitation with respect to the specific apparatus illustrated herein is intended or should be inferred. It is, of course, intended to cover by the appended claims all such modifications as fall within the scope of the claims. Further, logic methods depicted in the figures do not require the particular order shown, or sequential order, to achieve desirable results. Other steps can be provided, or steps can be eliminated, from the described flows, and other components can be add to, or removed from the described embodiments.

What is claimed is:

1. A device for dispensing an expandable substance comprising:
a liquid storage portion having first and second liquid storage chambers in communication with a liquid passageway;
a mixing portion comprising a mixing tube and a static mixer, the mixing tube having an elongated body with an interior passageway between opposing first and second ends, the second end of the mixing tube being secured to the storage portion, the static mixer being housed within the interior passageway of the mixing tube and comprising a plurality of curved baffles; and
a dispensing portion comprising a reservoir and a nozzle tip, the reservoir having a first end secured to the first end of the mixing tube and in liquid communication therewith and a second end communicating with a nozzle tip, the nozzle tip comprising a plurality of tine segments, each segment having a distal tip with an external gripping flange.

2. The device of claim 1 where the first and second liquid storage chambers are oriented substantially parallel to each other and arranged symmetrically around a longitudinal axis of the storage portion.

3. The device of claim 1 further comprising a connector, the liquid storage portion and mixing tube being releasably secured by the connector, the connector being a national pipe thread connection.

4. The device of claim 1 further comprising a check valve disposed within the reservoir, the check valve having a movable closing member, the closing member being movable away from a seated position, an opening between the mixing tube and reservoir being sealed when the closing member is in the seated position, the closing member having a larger diameter than the opening.

5. The device of claim 4 further comprising a breakaway portion and plunger in the interior of the nozzle tip, the plunger extending from a distal end of the nozzle tip into the reservoir.

6. A method for mixing and dispensing an expandable substance comprising the steps of:
providing a storage portion for holding separate components that create the expandable substance when mixed together;
delivering the components to a mixing portion that combines the components into the expandable substance; and
dispensing the expandable substance through a nozzle tip having a plurality of segments, each segment having a gripping protrusion on a distal tip, and the segments connected by a breakaway portion, after the breakaway portion has been removed from the nozzle tip and the gripping protrusions engage a structure through which the expandable substance is dispensed.

7. The method of claim 6 wherein the expandable substance is dispensed through an opening in a concrete slab.

8. A device for dispensing a foam at a structure comprising:
a separation portion having a plurality of compartments, each compartment communicating with a channel, the separation portion for containing and keeping separate the ingredients for the foam;
a combination portion communicating with the channels, the combination portion for combining the components kept separate in the separation portion; and
a delivery portion comprising:
a valve communicating with the combination portion and with a nozzle tip, the valve transporting the combined components from the combination portion to the nozzle tip, the valve allowing flow in a direction away from the combination portion; and
a nozzle tip comprising a plurality of sections, each section having a projection on an external surface of a distal end of the section;
wherein the nozzle device keeps the ingredients for the foam apart in the separation portion, delivers the ingredients to the combination portion for blending together, and delivers the combined ingredients through the nozzle tip after the breakaway portion is removed from the nozzle tip.

9. The nozzle device of claim 8, each projection comprising a contact portion for contacting the structure while the nozzle device is dispensing the foam.

10. A nozzle device of claim 9, wherein the contact portions engage the structure to prevent the nozzle device from disengaging from the structure while the nozzle device is dispensing the foam.

11. A nozzle device of claim 9, wherein separation portions include tapering channels.

12. A nozzle device of claim 9, wherein the combination portion comprises an adapter that communicates with the channels and communicates with the delivery portion.
